(19) United States
(12) Patent Application Publication
(10) Pub. No.: US 2022/0092663 A1
(43) Pub. Date: Mar. 24, 2022

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Jun UCHIMURA, Tokyo (JP); Yuusuke KAYANO, Tokyo (JP); Takahiro MATSUI, Tokyo (JP); Toshikazu NAKAJIMA, Tokyo (JP)

(73) Assignee: NEC Corporation, Minato-ku, Tokyo (JP)

(21) Appl. No.: 17/424,377

(22) PCT Filed: Mar. 10, 2020
(86) PCT No.: PCT/JP2020/010155

§ 371 Date: Jul. 20, 2021

(30) Foreign Application Priority Data
Mar. 22, 2019 (JP) 2019-054692

(51) Int. Cl. G06Q 30/06; G06V 10/22; G06V 20/50; G06V 10/10

(52) U.S. Cl. CPC G06Q 30/0623; G06V 10/22; G06Q 30/0633; G06V 10/16; G06V 20/50

(57) ABSTRACT

This information processing device is provided with: an image acquisition unit that acquires a commodity image obtained by photographing commodities at a store; an image manipulation unit that manipulates the commodity image on the basis of a manipulation instruction for the commodity image, the instruction being received from a customer information terminal; and an identification unit that identifies the customer needs for the commodities at the store on the basis of the manipulated commodity image.

### TECHNICAL FIELD

The present disclosure relates to an information processing device and the like.

### BACKGROUND ART

A customer cannot know whether there is a desired commodity in a store until the customer comes to the store. For this reason, the customer may move from store to store until finding the commodity.

PTL 1 discloses a technique in which a server device transmits a real-time image of a displayed commodity captured by a camera to a communication terminal, selects a commodity from the real-time image using the communication terminal, generates order data, and transmits the order data to a store server in order to improve convenience for customers. PTL 2 discloses a technique of displaying a live video of a commodity while operating a camera for imaging the commodity on a user terminal of a customer, and selecting and ordering a commodity from the displayed video.

### CITATION LIST

### Patent Literature

[PTL 1] JP 2003-099629 A

[PTL 2] JP 2005-216005 A

### SUMMARY OF INVENTION

### Technical Problem

In order to improve the sales of a store, it is important to have a selection of commodities and a stock of commodities that meet the needs of customers who visit the store. With the techniques of PTLs 1 and 2, it is not possible to grasp the needs of customers before purchase.

An object of the present disclosure is to provide an information processing device and the like that enable a customer to check a stock of commodities of a store and enables a store to grasp a need of a customer.

### Solution to Problem

An information processing device as an aspect of the present disclosure includes: an image acquisition unit that acquires a commodity image obtained by imaging a commodity of a store; an image operation unit that operates the commodity image based on an operation instruction for the commodity image received from an information terminal of a customer; and a specification unit that specifies a need of the customer for the commodity of the store based on the commodity image that has been subjected to operation.

An information processing method as a mode of the present disclosure includes: acquiring a commodity image obtained by imaging a commodity of a store; performing image operation on the commodity image based on an operation instruction for the commodity image received from an information terminal of a customer; and specifying a need of the customer for the commodity of the store based on the commodity image that has been subjected to operation.

A program stored in a recording medium as a mode of the present disclosure causes a computer to: acquire a commodity image obtained by imaging a commodity of a store; perform image operation on the commodity image based on an operation instruction for the commodity image received from an information terminal of a customer; and specify a need of the customer for the commodity of the store based on the commodity image that has been subjected to operation.

### Advantageous Effects of Invention

According to the present disclosure, a customer can check a stock of commodities of a store, and a store can grasp a need of a customer.

### BRIEF DESCRIPTION OF DRAWINGS

FIG. 1 is a diagram illustrating an outline of an information processing system according to a first example embodiment.

FIG. 2 is a block diagram illustrating an example of a configuration of an information processing device according to the first example embodiment.

FIG. 3 is a block diagram illustrating an example of a configuration of an information terminal according to the first example embodiment.

FIG. 4 is a diagram illustrating an example of a commodity located in a central region of a commodity image.

FIG. 5 is a sequence diagram illustrating an example of operation of the information processing system according to the first example embodiment.

FIG. 6 is a block diagram illustrating an example of a configuration of an information processing device according to a second example embodiment.

FIG. 7 is a block diagram illustrating an example of a configuration of an information processing device according to a third example embodiment.

FIG. 8 is a sequence diagram illustrating part of operation of an information processing system according to the third example embodiment.

FIG. 9 is a block diagram illustrating an example of a configuration of an information processing system according to a fourth example embodiment.

FIG. 10 is a sequence diagram illustrating an example of operation of the information processing system according to the fourth example embodiment.

FIG. 11 is a diagram illustrating a hardware configuration by a computer.

### EXAMPLE EMBODIMENT

### First Example Embodiment

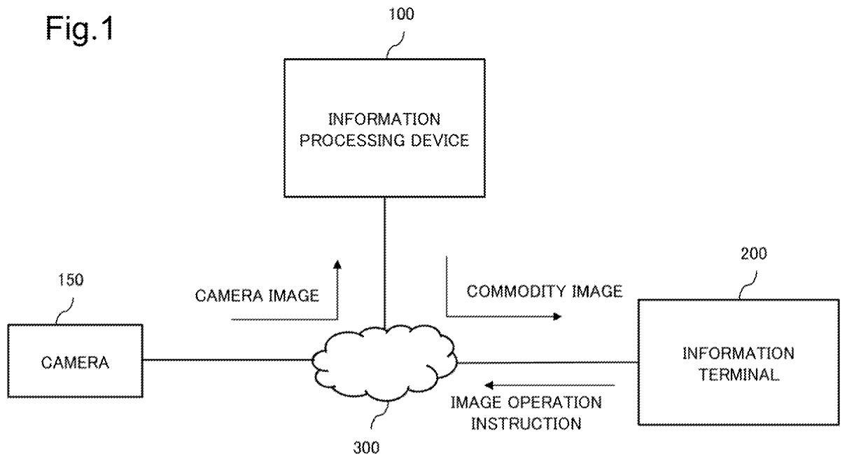

An information processing device according to a first example embodiment will be described with reference to the drawings. FIG. 1 is a diagram illustrating an outline of an information processing system according to the first example embodiment. The information processing system illustrated in FIG. 1 includes an information processing device 100, a camera 150, and an information terminal 200. The information processing device 100, the camera 150, and the information terminal 200 are communicably connected via a network 300.

(Camera)

The camera 150 images a commodity of a store, and transmits the captured camera image to the information processing device 100. The commodity of the store to be imaged may be any of a commodity unit of the store, a shelf tier unit of the display shelf, and a display shelf unit. The camera image includes at least one commodity of the store. The imaging of the commodity of the store and the transmission of the camera image by the camera 150 are performed every predetermined period. A predetermined period may be, for example, in units of 10 minutes or in units of 1 hour. The camera image may be a video. The camera 150 is, for example, a network camera. The display shelf is also referred to as a display fixture. The display fixture is a store fixture for displaying commodities. The display fixture includes a display hook, a showcase, and the like in addition to the display shelf. In a case where there is a plurality of cameras 150, each camera 150 transmits a camera identifier together with a camera image to the information processing device 100. The camera 150 may image a commodity for each different store and transmit a camera image to the information processing device 100. The camera 150 only needs to have such resolution that the commodity can be detected (identified) by the information processing device 100 even if the camera image is enlarged.

The store where the camera is installed may be a store such as a supermarket, a convenience store, a mass retailer, or a department store, or may be a retail store. The store may be a branch store such as a local store, an unattended store, a satellite store, or a store, or a main store that replenishes commodities to the satellite store.

(Information Processing Device)

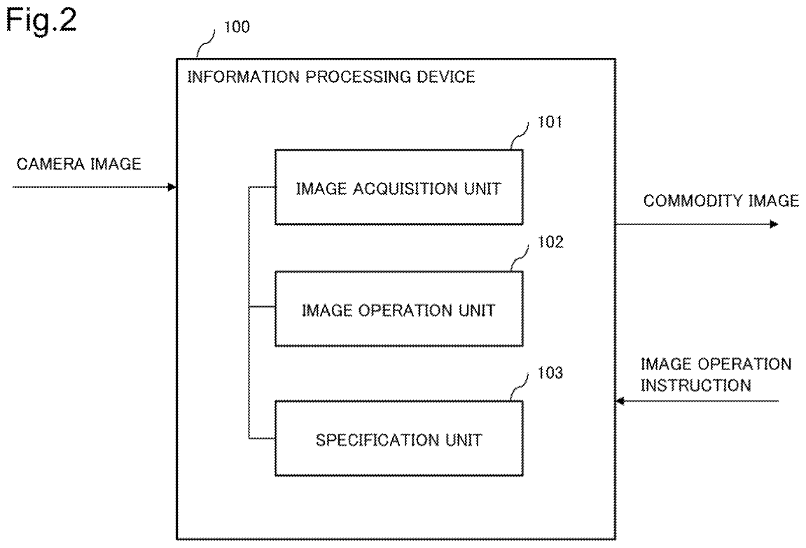

An information processing device according to a first example embodiment will be described with reference to the drawings. FIG. 2 is a block diagram illustrating an example of a configuration of an information processing device according to the first example embodiment. An information processing device 100 illustrated in FIG. 2 includes: an image acquisition unit 101 that acquires a commodity image obtained by imaging a commodity of a store; an image operation unit 102 that operates the commodity image on the basis of an operation instruction for the commodity image received from an information terminal of a customer; and a specification unit 103 that specifies a need of the customer for the commodity of the store on the basis of the commodity image that has been subjected to operation. The information processing device 100 is, for example, a computer. The computer may be a server installed in a store or a cloud computer.

For example, the image acquisition unit 101 receives the camera image obtained by imaging the commodity of the store from the camera 150, and acquires the commodity image obtained by imaging the commodity of the store on the basis of the camera image. The commodity image includes at least one commodity of the store. The commodity image may be the entire camera image or a part of the camera image. The commodity image may be obtained by editing the camera image. In a case where there is a plurality of cameras 150, the image acquisition unit 101 receives a camera image related to each camera 150. In a case where the camera image is a video, the image acquisition unit 101 cuts out a video frame constituting the video and acquires a commodity image. The image acquisition unit 101 provides the acquired commodity image to the image operation unit 102.

The image acquisition unit 101 may receive a commodity image operated by the image operation unit 102 to be described later from the image operation unit 102 as necessary, duplicate the operated commodity image, and provide the commodity image to the information terminal 200.

The image operation unit 102 operates the commodity image on the basis of the operation instruction for the commodity image received from the information terminal of the customer.

Specifically, the image operation unit 102 receives an operation instruction from the information terminal 200 and performs operation on the acquired commodity image according to the operation instruction. The image operation is, for example, at least one of image enlargement, image rotation, and image movement with respect to the commodity image. The image operation unit 102 duplicates the commodity image that has been subjected to the operation and provides the duplicated images to the specification unit 103 and the information terminal 200. The image operation unit 102 may provide the commodity image that has been subjected to the operation to the information terminal 200 via the image acquisition unit 101 as necessary.

The specification unit 103 receives the operated commodity image and specifies the need of the customer for the commodity of the store on the basis of the operated commodity image. The need of the customer is a commodity that the customer desires to purchase at a store where the customer visits, or a category of the commodity.

First, the specification unit 103 detects a commodity included in the commodity image that has been subjected to the operation. For detection of a commodity included in a commodity image, for example, a known image recognition technology in which a deep learning technology and a feature point matching technology are combined is used. When recognizing one commodity from the commodity image that has been subjected to the operation, the specification unit 103 specifies the recognized commodity as the customer's need.

In a case where equal to or more than two commodities are recognized from the commodity image that has been subjected to the operation, a commodity located in a predetermined region of the commodity image is specified as the customer's need. The predetermined region of the commodity image is, for example, a central region of the commodity image. The central region refers to a region in a predetermined range from the vicinity of the center of the commodity image. Being located in the central region means a state in which at least a part of a commodity is included in the central region. In a case where a part of equal to or more than two commodities is included in the central region, a commodity having a large area included in the central region is specified as the customer's need.

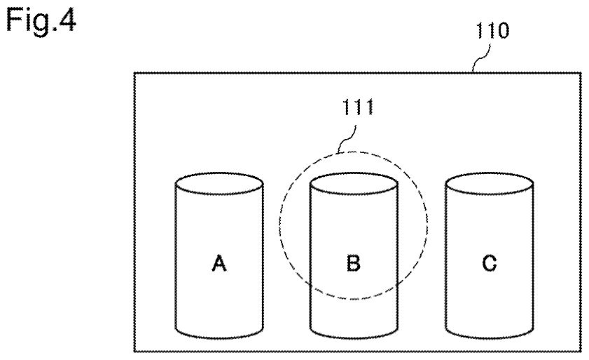

FIG. 4 is a diagram illustrating an example of a commodity located in a central region of a commodity image. In FIG. 4, a central region 111 is indicated by a broken line circle. The specification unit 103 performs image recognition of the commodity image 110 to recognize a beverage A, a beverage B, and a beverage C as commodities, and further specifies the beverage B in which the central region 111 is located as a customer's need. In FIG. 4, an example in which the central region 111 of the commodity image is circular has been described, but the present disclosure is not limited thereto. For example, the shape may be a polygon.

The predetermined region is not limited to the central region. For example, it may be either the left region or the right region of the commodity image. The number of the predetermined regions is not limited to one, and may be plural.

The detection of the commodity included in the commodity image by the specification unit 103 is not limited to the image recognition technology. For example, the specification unit 103 may detect a commodity on a display shelf from a commodity image that has been subjected to operation by using commodity coordinate data in which a commodity image including the display shelf and the commodity is associated with a position of the display shelf and the commodity generated on the basis of shelf allocation information of the display shelf, and specify a need of the customer. Specifically, commodity coordinate data of commodities in the display shelf generated from a commodity image as a reference including the commodities displayed in the display shelf imaged in advance and shelf allocation information is prepared. The specification unit 103 detects the commodity included in the commodity image that has been subjected to the operation on the basis of an enlargement magnification, a rotation angle, and a movement distance of the commodity image according to the operation instruction from the center coordinates of the commodity image as a reference.

A plurality of operation instructions may lead to a commodity in which the customer is interested from the commodity image that has been subjected to operation. Therefore, the specification unit 103 may specify the need of the customer on the basis of a reception situation of the operation instruction instead of always detecting the commodity from the commodity image that has been operated and specifying the need of the customer.

For example, the image operation unit 102 acquires the reception status of the operation instruction, and the specification unit 103 specifies the need of the customer from the commodity image on the basis of the acquired reception status of the operation instruction. The reception status is, for example, a reception interval (reception time interval) or a reception frequency.

Specifically, the image operation unit 102 measures a time interval at which an operation instruction is received from the information terminal 200. In a case where the time interval of reception is shorter than a predetermined time interval, the specification unit 103 determines that the customer is still searching for the commodity from the commodity image that has been subjected to operation, and does not specify the customer's need from the commodity image that has been subjected to operation. On the other hand, in a case where the time interval of reception is longer than the predetermined time interval, the specification unit 103 determines that the customer has reached the commodity of interest, and specifies the customer's need from the commodity image that has been subjected to operation.

Alternatively, the image operation unit 102 measures a reception frequency at which an operation instruction is received from the information terminal 200. The reception frequency is, for example, the number of times of receiving an operation instruction within a unit time. In a case where the reception frequency is higher than a predetermined reception frequency, the specification unit 103 determines that the customer is still searching for the commodity from the commodity image that has been subjected to operation, and does not specify the customer's need from the commodity image that has been subjected to operation. On the other hand, in a case where the reception frequency is lower than the predetermined reception frequency, the specification unit 103 determines that the customer has reached the commodity of interest, and specifies the customer's need from the commodity image that has been subjected to operation.

The specification unit 103 may detect a commodity included in the commodity image that has been subjected to operation according to the last received operation instruction and specify the detected commodity as the customer's need.

(Information Terminal)

Next, an information terminal according to the first example embodiment will be described with reference to the drawings. The information terminal 200 is a terminal used by a customer. The customer is a person who uses the store or a person who may use the store. The information terminal 200 is, for example, a computer or a smartphone.

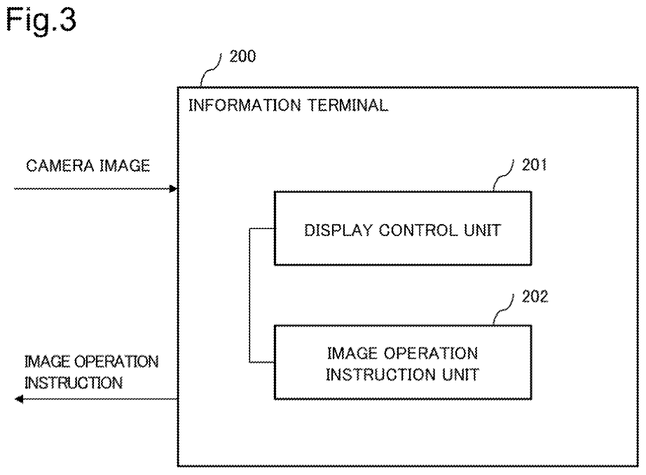

FIG. 3 is a block diagram illustrating an example of an information terminal according to the first example embodiment. The information terminal 200 includes a display control unit 201 and an image operation instruction unit 202. The information terminal 200 requests the information processing device 100 for a commodity image obtained by imaging a commodity of a store. For example, the information terminal 200 requests the information processing device 100 to download a commodity image via browser software included in the information terminal 200.

The display control unit 201 displays the commodity image received from the information processing device 100 on a display (not illustrated). The commodity image is a commodity image acquired based on the camera image or a commodity image that has been subjected to operation.

The image operation instruction unit 202 instructs the information processing device 100 to perform image operation on the commodity image of the duplication source. The image operation instruction unit 202 receives image operation on the provided commodity image input by the customer via an input device (not illustrated). The image operation instruction unit 202 transmits the received image operation to the information processing device 100 as an operation instruction. The operation instruction includes enlargement operation, rotation operation, movement operation, or the like on the commodity image. The movement operation is an operation of moving in any direction in the plane of the display screen. The movement operation is also called a sliding operation.

The input device is, for example, a touch pad, a touch panel, an operation key, or the like. The operation key may be a hardware key or a software key.

Next, operation of the information processing system according to the first example embodiment will be described with reference to the drawings. The description of the operation of the information processing system includes description of the operation of the information processing device 100 and the operation of the information terminal 200.

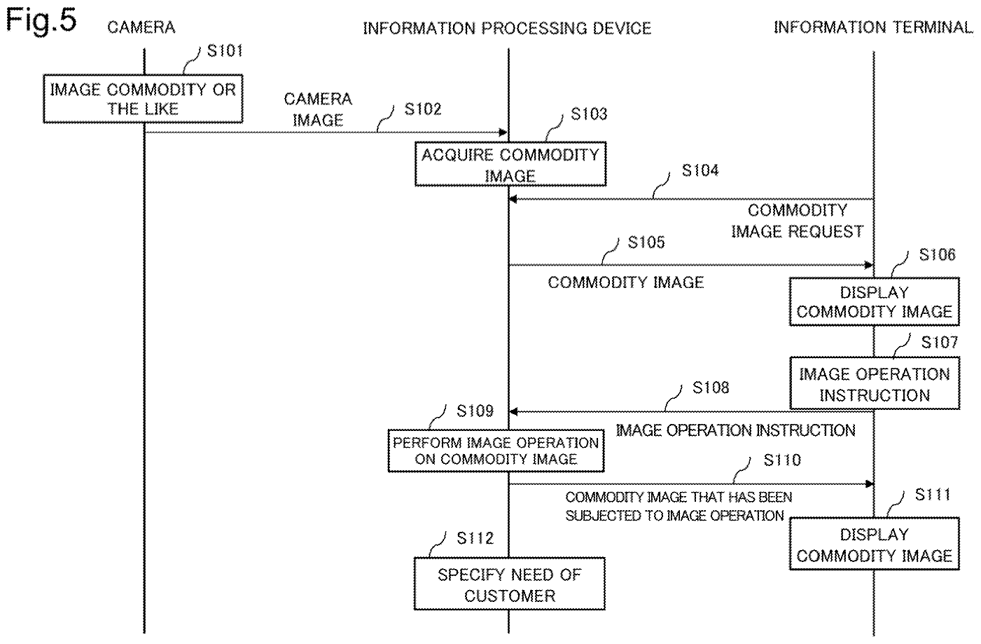

FIG. 5 is a sequence diagram illustrating an example of operation of the information processing system according to the first example embodiment.

The camera 150 images a commodity of the store (Step S101), and transmits the captured camera image to the information processing device 100 (Step S102). The camera image includes at least one commodity of the store.

The image acquisition unit 101 of the information processing device 100 acquires the camera image from the camera 150 as a commodity image obtained by imaging a commodity of the store (Step S103). The commodity image includes at least one commodity of the store.

The information processing device 100 receives a request to provide the commodity image in which the commodity of the store is imaged from the information terminal 200 (S104). The image acquisition unit 101 duplicates the acquired commodity image and provides the commodity image to the information terminal 200 (Step S105).

The display control unit 201 of the information terminal 200 displays the commodity image received from the information processing device 100 on the display (Step S106).

The image operation instruction unit 202 instructs the information processing device 100 to perform image operation on the commodity image of the duplication source. Specifically, the image operation instruction unit 202 receives image operation on the provided commodity image input by the customer via an input device (not illustrated). The image operation instruction unit 202 transmits the received image operation to the information processing device 100 as an operation instruction (Step S107).

The image operation unit 102 of the information processing device 100 operates the commodity image on the basis of the operation instruction for the commodity image received from the information terminal of the customer. Specifically, the image operation unit 102 receives an operation instruction from the information terminal 200 (Step S108) and performs operation on the commodity image according to the operation instruction (Step S109). The image operation is, for example, at least one of image enlargement, image rotation, and image movement with respect to the commodity image. The image operation unit 102 duplicates the commodity image that has been subjected to the operation and provides the duplicated images to the information terminal 200 (Step S110). The information terminal 200 receives the commodity image and displays the received commodity image (Step S111).

The specification unit 103 specifies the need of the customer for the commodity of the store on the basis of the operated commodity image (Step S112).

### (Effects of First Example Embodiment)

According to the first example embodiment, the information processing device 100 provides the commodity image in which the commodity of the store is imaged to the information terminal 200 of the customer. As a result, the commodity image provided by the information processing device 100 is displayed, so that the customer can confirm a stock or selection of commodities of the store.

An operation instruction on the commodity image is transmitted from the information terminal 200 of the customer to the information processing device 100, so that the information processing device 100 performs operation on the commodity image on the basis of the operation instruction. The information processing device 100 specifies a commodity included in the commodity image that has been subjected to operation on the basis of the operation instruction as a customer's need. As a result, the customer can check a stock of commodities of the store, and the store can grasp the need of the customer.

In the technology in which a customer operates a World Wide Web (WEB) camera to display a commodity image as in PTL 2, there is a possibility that a customer occupies the WEB camera, and there is a possibility that a customer cannot use the WEB camera even if the customer wants to check the commodity of the store. On the other hand, in the first example embodiment, the information processing device 100 can duplicate the commodity image acquired from the camera image and provide the duplicated commodity image to a plurality of customers. Since the information processing device 100 operates the commodity image on the basis of the operation instruction from the customer, the response of the image operation of the commodity image becomes remarkably faster than the operation of the WEB camera, and the convenience of the customer can be enhanced.

The information processing device 100 performs image operation on the commodity image on the basis of the operation instruction from the information terminal 200 of the customer, and specifies the customer's need on the basis of the commodity screen on which the image operation has been performed. Therefore, it is possible to grasp the customer's need without making the customer aware of it.

### Second Example Embodiment

Next, an information processing device according to a second example embodiment will be described with reference to the drawings. The second example embodiment is different from the first example embodiment in that the information processing device 100 further includes an order placement unit. Hereinafter, in the description of the information processing device 100 of the second example embodiment, the same components as those of the first example embodiment are denoted by the same reference numerals, and a detailed description thereof will be omitted.

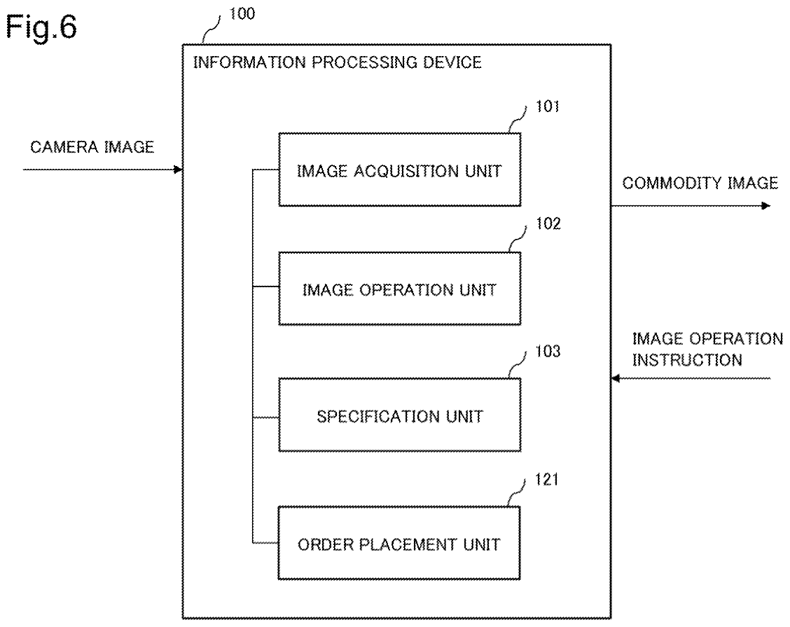

FIG. 6 is a block diagram illustrating an example of a configuration of an information processing device according to the second example embodiment. The information processing device 100 illustrated in FIG. 6 includes the image acquisition unit 101, the image operation unit 102, the specification unit 103, and an order placement unit 121. The order placement unit 121 is, for example, an order management system in a store. The order placement unit 121 stores order placement information, and places an order for a commodity on the basis of the order placement information. The order placement information includes a commodity name, an order quantity, and the like.

The order placement information is updated on the basis of the specified need of the customer. For example, the specification unit 103 adds a commodity included in the specified customer's need to the order placement information or increases and updates the order quantity of the commodity. The order placement unit 121 may automatically place an order for a commodity on the basis of the order placement information. A clerk may update the order placement information on the basis of the commodity included in the specified customer's need via an input device such as a keyboard.

The specification unit 103 may update the order placement information on the basis of a result of analyzing the specified customer's need. For example, the specification unit 103 ranks the need of the customers of a large number of identified customers in descending order based on the specified need of the customers, and updates the order placement information on the basis of the need of the customers ranked high.

According to the second example embodiment, it is possible to place an order for a commodity reflecting the need of the customers specified by the specification unit 103 and the order placement unit 121 of the information processing device 100.

In a case where the information processing device 100 specifies the need of the customer specified from a commodity image of another store, the specification unit 103 may separately acquire the need of the customer specified on the basis of the commodity image of the another store and update the order placement information. As a result, it is possible to achieve the commodity selection reflecting the need of the customers in the store.

The specified need of the customer may be transmitted to an analysis system that analyzes aggregated data. For example, by sending the specified need of the customer to a headquarter system that is connected with a POS terminal of a store chain or a store server and having a trend analysis function for a commodity, it is also possible to perform feedback to the trend analysis of the commodity, for example.

### Third Example Embodiment

Next, an information processing device according to a third example embodiment will be described with reference to the drawings. The information processing device 100 of the third example embodiment is different from the information processing device 100 of the first example embodiment in that the image acquisition unit 101 includes an image composition unit. In the description of the third example embodiment, the same components as those of the first example embodiment are denoted by the same reference numerals, and a detailed description thereof will be omitted.

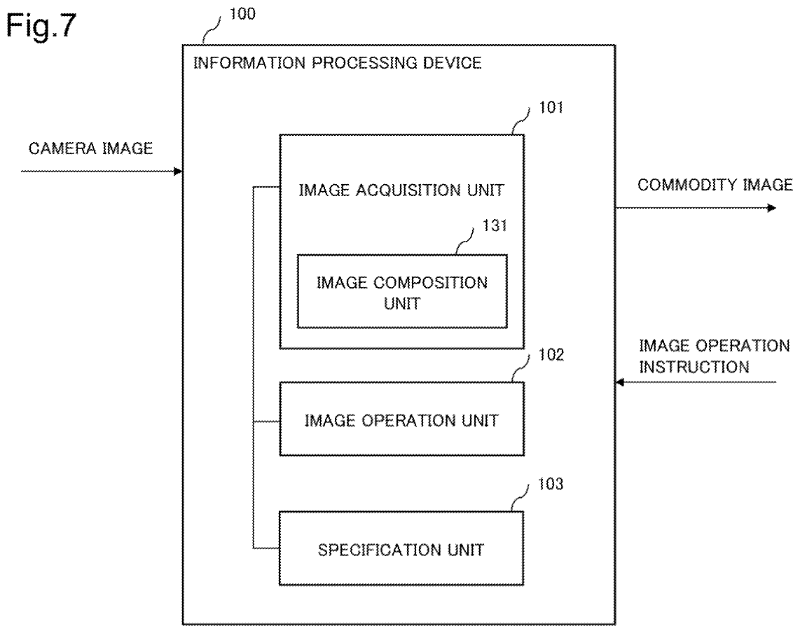

FIG. 7 is a block diagram illustrating an example of a configuration of the information processing device 100 according to the third example embodiment. The information processing device 100 includes the image acquisition unit 101, the image operation unit 102, and the specification unit 103, and the image acquisition unit 101 includes an image composition unit 131.

The image acquisition unit 101 detects a person included in the commodity image acquired from the camera image of the camera 150 using an image recognition technology. The image composition unit 131 of the image acquisition unit 101 combines a plurality of commodity images in which a person is captured at different positions with respect to a commodity image including the person, and generates a commodity image not including the person. The image acquisition unit 101 provides the commodity image in which the person is not included to the information terminal 200.

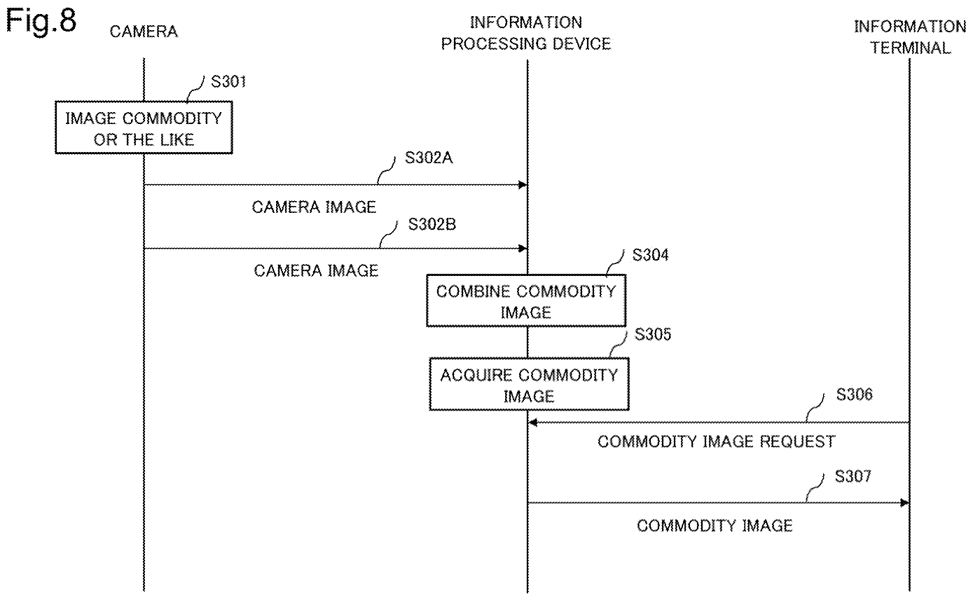

FIG. 8 is a sequence diagram illustrating part of operation of the information system according to the third example embodiment. Steps S301 to S305 indicating the operation of the information processing device 100 illustrated in FIG. 8 correspond to Steps S101 to S105 indicating the operation of the information processing device 100 of the first example embodiment.

The camera 150 acquires the camera image from the camera 150 as a commodity image obtained by imaging a commodity of the store (Step S301). The camera 150 transmits camera images captured at predetermined time intervals (Step S302A, Step S302B).

When the image acquisition unit 101 detects a person in the commodity image acquired from the camera image of the camera 150, the image composition unit 131 combines a plurality of commodity images in which a person is captured at different positions with respect to the commodity image in which the person is included in the commodity image (Step S304), and acquires the commodity image in which the person is not included (S305).

The information processing device 100 receives a request to provide the commodity image in which the commodity of the store is imaged from the information terminal 200. The image acquisition unit 101 duplicates the acquired commodity image and provides the commodity image to the information terminal 200 (Step S307). Steps subsequent to Step S307 are similar to steps subsequent to Step S106 in the operation of the information processing device 100 according to the first example embodiment.

According to the third example embodiment, even when a person appears in a camera image obtained by imaging a commodity in a store, the commodity image from which the person has been removed can be provided to the information terminal 200 of the customer. As a result, it is possible to protect the privacy of a person who uses the store where the commodity is imaged by the camera 150.

### Fourth Example Embodiment

An information processing system according to a fourth example embodiment will be described with reference to the drawings. The information processing system according to the fourth example embodiment is a modification of the information processing system according to the first example embodiment.

The information processing system according to the fourth example embodiment performs image operation on the commodity image provided from the information processing device 100 by the information terminal 200, and transmits the operation information to the information processing device 100. It can also be said that the operation information transmitted by the information terminal 200 is an operation instruction in the first example embodiment.

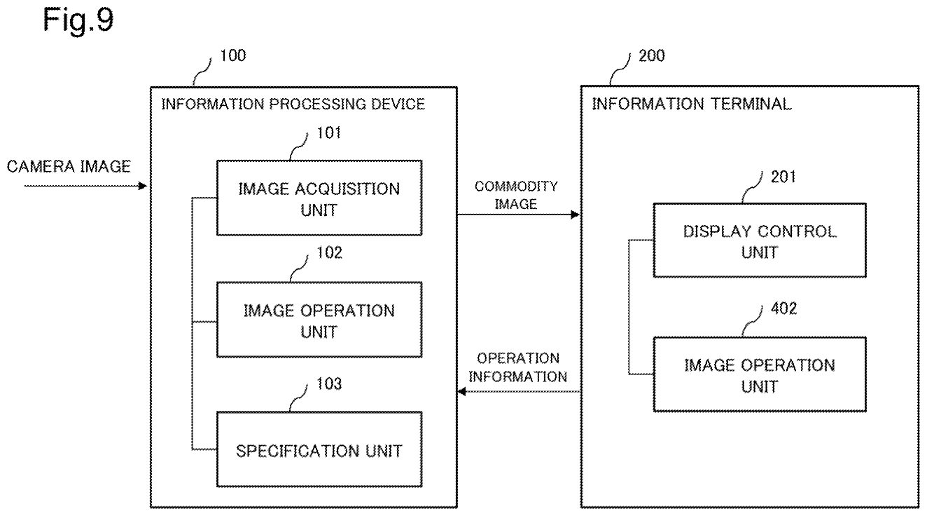

FIG. 9 is a block diagram illustrating a configuration of an information processing system according to the fourth example embodiment. In the information processing system illustrated in FIG. 9, the same components as those of the information processing device 100 and the information terminal 200 of the first example embodiment are denoted by the same reference numerals, and detailed description thereof is omitted. The information terminal 200 of the fourth example embodiment includes an image operation unit 402.

The image operation unit 402 operates the commodity image provided to the information terminal 200 on the basis of an image operation input from a customer. The image operation is, for example, image enlargement, image rotation, or image movement with respect to the commodity image. The image operation unit 402 transmits operation information for image operation to the information processing device 100. The operation information may include an operation history of image operation of a commodity image on the information terminal 200. The information processing device 100 specifies the need of the customer for a commodity of the store on the basis of the commodity image that has been subjected to the operation by the operation information.

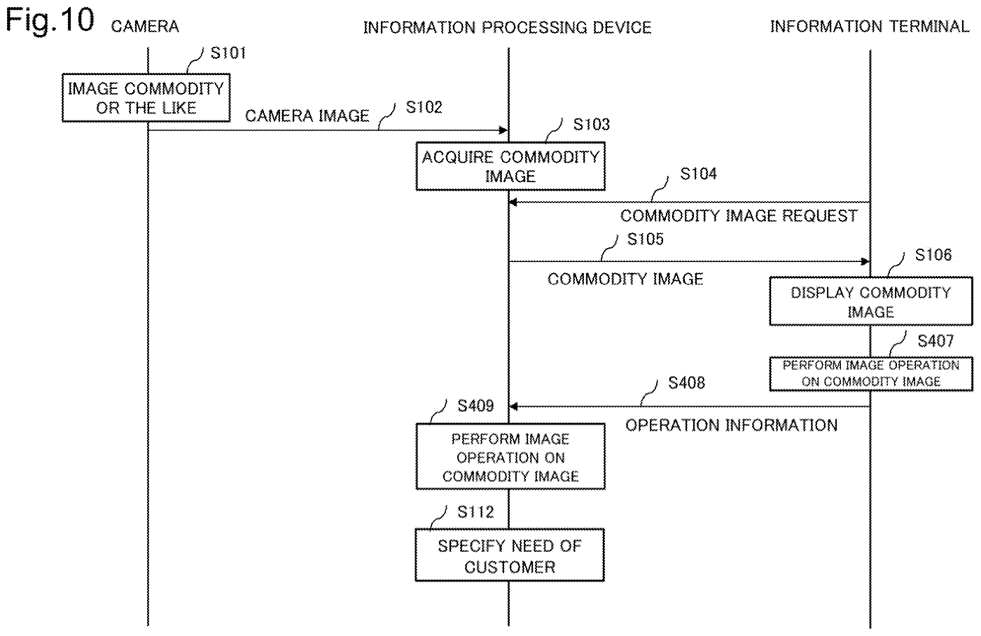

Operation of the information processing system according to the fourth example embodiment will be described with reference to the drawings. FIG. 10 is a sequence diagram illustrating an example of operation of the information processing system according to the fourth example embodiment. In the operation of the information processing system according to the fourth example embodiment illustrated in FIG. 10, steps are denoted by the same step numbers as those in the information processing system of the first example embodiment, and detailed description thereof is omitted.

The display control unit 201 of the information terminal 200 displays the commodity image provided from the information processing device 100 (Step S106), and the image operation unit 402 performs operation on the commodity image on the basis of the image operation input from the customer (Step S407). The image operation unit 402 transmits the operation information on the image operation to the information processing device 100 (Step S408).

The image operation unit 102 of the information processing device 100 performs image operation on the commodity image on the information processing device side on the basis of the received operation information (Step S409), and the specification unit 103 specifies the customer's need for the commodity of the store on the basis of the commodity image that has been subjected to operation (Step S112).

(Effects of Fourth Example Embodiment)

According to the fourth example embodiment, the information terminal 200 performs image operation on the commodity image and transmits operation information to the information processing device 100. As a result, the information processing device 100 does not need to transmit the commodity image that has been subjected to operation for each operation instruction to the information terminal 200, and the load of the information processing device 100 can be reduced and the load of the transmission system between the devices can also be reduced.

### Fifth Example Embodiment

For example, when a user touches a commodity displayed with a finger on a commodity image that has been subjected to operation and is displayed on the display of the information terminal 200, commodity-related information such as price information, ranking, and a purchase recommendation commodity regarding the commodity touched with the finger may be popped up on the display of the information terminal 200. As the commodity for displaying the commodity-related information, a commodity located in the central region of the commodity image is preferable.

In order to display the above-described commodity-related information on the display of the information terminal 200, the specification unit 103 of the information processing device 100 detects a commodity from a commodity image that has been operated using an image recognition technology, and then searches a commodity-related information DB (not illustrated) for the detected commodity to extract the commodity-related information. The commodity-related information DB is a storage device in which price information, ranking, and a purchase recommendation commodity are stored in association with each other for each commodity of the store.

The information terminal 200 transmits, for example, coordinates touched by a finger on the display with a touch panel to the information processing device 100, so that the specification unit 103 of the information processing device 100 can detect the commodity touched by the finger from the commodity image that has been subjected to operation.

According to the fifth example embodiment, the convenience of the customer can be enhanced as compared with the information processing system in the first to fifth example embodiments.

(Hardware Configuration)

In each of the example embodiments described above, each component of the information processing device 100 and the information terminal 200 represents a functional unit block. A part or all of each component of each device may be achieved by any combination of a computer and a program.

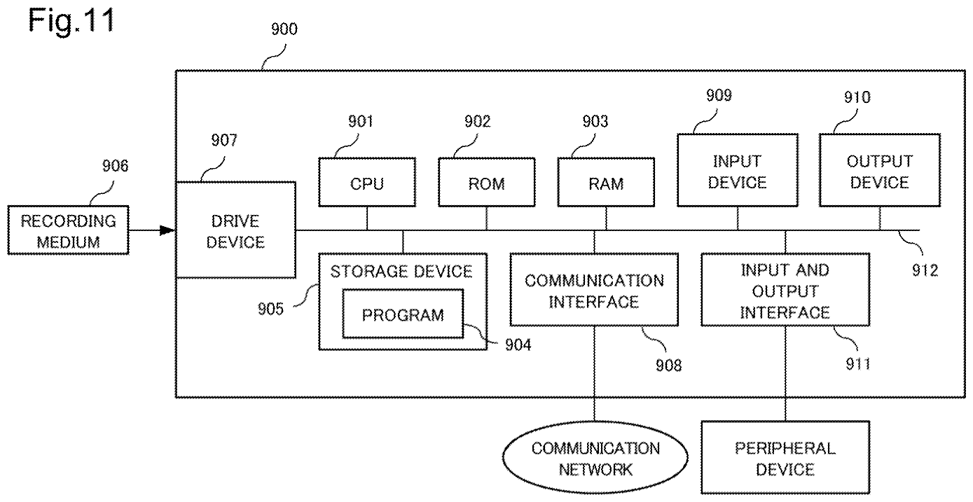

FIG. 11 is a block diagram illustrating an example of a hardware configuration of a computer. Referring to FIG. 11, a computer 900 includes, for example, a central processing unit (CPU) 901, a read only memory (ROM) 902, a random access memory (RAM) 903, a program 904, a storage device 905, a drive device 907, a communication interface 908, an input device 909, an output device 910, and a bus 912.

The program 904 includes instructions for implementing the functions of the information processing device 100 and the information terminal 200. The program 904 is stored in advance in the ROM 902, the RAM 903, and the storage device 905. The CPU 901 implements the functions of the information processing device 100 and the information terminal 200 by executing instructions included in the program 904. For example, the CPU 901 of the information processing device 100 executes an instruction included in the program 904 to implement the function of the configuration. The RAM 903 may temporarily store data to be processed by each function of the information processing device 100 and the information terminal 200.

The drive device 907 performs reading and writing of the recording medium 906. The communication interface 908 provides an interface with a communication network. The input device 909 is, for example, a mouse, a keyboard, or the like, and receives an input of information from a customer or the like. The output device 910 is, for example, a display, and outputs (displays) information to a customer or the like. The input and output interface 911 provides an interface with a peripheral device. In the case of the information processing device 100, the above-described camera, barcode reader, tag reader/writer, and card reader/writer 118 may be connected to the input and output interface 911. The bus 912 connects the components of the hardware. The program 904 may be supplied to the CPU 901 via a communication network, or may be stored in the recording medium 906 in advance, read by the drive device 907, and supplied to the CPU 901.

The hardware configuration illustrated in FIG. 11 is an example, and other components may be added or some components may not be included.

There are various modifications of the implementation method of each device. For example, each device may be implemented by any combination of a computer and a program different for each component. A plurality of components included in each device may be implemented by any combination of one computer and a program.

Some or all of the components of each device may be implemented by general-purpose or dedicated circuitry including a processor or the like, or a combination thereof. The circuitry may include a single chip or may include a plurality of chips connected via a bus. A part or all of each component of each device may be achieved by a combination of the above-described circuitry or the like and a program.

In a case where a part or all of each component of each device is achieved by a plurality of computers, circuits, and the like, the plurality of computers, circuits, and the like may be arranged in a centralized manner or in a distributed manner.

In each example embodiment, the steps describing the series of processing described above include not only processing performed in chronological order according to the described order, but also processing that is not necessarily performed in chronological order and is performed in parallel or individually.

The example embodiments are not limited to the above-described example embodiments, and various modifications are possible, and example embodiments obtained by appropriately combining configurations, operations, and processes disclosed in different example embodiments are also included in the technical scope of the present disclosure.

Although the above-described example embodiments have been described as exemplary examples, the present invention is not limited to the above-described example embodiments. That is, various aspects that can be understood by those skilled in the art can be applied to the example embodiments in the present disclosure.

The whole or part of the example embodiments above can be described as, but are not limited to, the following supplementary notes.

(Supplementary Note 1)

An information processing device including:

image acquisition means for acquiring a commodity image obtained by imaging a commodity of a store;

image operation means for operating the commodity image based on an operation instruction for the commodity image received from an information terminal of a customer; and

specification means for specifying a need of the customer for the commodity of the store based on the commodity image that has been subjected to operation.

(Supplementary Note 2)

The information processing device according to Supplementary Note 1,

in which the specification means specifies the commodity included in the commodity image that has been subjected to the operation, as the need of the customer.

(Supplementary Note 3)

The information processing device according to Supplementary Note 1 or 2,

in which the specification means specifies the commodity in a predetermined region in the commodity image that has been subjected to the operation, as the need of the customer.

(Supplementary Note 4)

The information processing device according to any one of Supplementary Notes 1 to 3,

in which the image operation means acquires a reception status of the operation instruction, and

the specification means specifies the need of the customer from the commodity image that has been subjected to the operation in accordance with the reception status.

(Supplementary Note 5)

The information processing device according to any one of Supplementary Notes 1 to 4,

in which the commodity image includes a display fixture for displaying the commodity.

(Supplementary Note 6)

The information processing device according to Supplementary Note 5,

in which the specification means specifies the need of the customer based on commodity coordinate data related to commodity arrangement of the display fixture and generated based on shelf allocation information of the display fixture and based on the commodity image that has been subjected to the operation.

(Supplementary Note 7)

The information processing device according to any one of Supplementary Notes 1 to 6,

in which the operation instruction is at least one of image enlargement operation, image rotation operation, and image movement operation for the commodity image.

(Supplementary Note 8)

The information processing device according to any one of Supplementary Notes 1 to 7,

in which the image acquisition means transmits at least one of the commodity image that has been acquired and the commodity image that has been subjected to the operation to the information terminal.

(Supplementary Note 9)

The information processing device according to any one of Supplementary Notes 1 to 8, further including

order placement means for placing an order of the commodity based on order placement information,

in which the specification means updates the order placement information based on the need of the customer that has been specified.

(Supplementary Note 10)

The information processing device according to Supplementary Note 9,

in which the specification means updates the order placement information based on ranking of a number of needs that has been specified, based on the need of the customer that has been specified.

(Supplementary Note 11)

The information processing device according to Supplementary Note 1,

in which a target of the need of the customer is the commodity or a category of the commodity.

(Supplementary Note 12)

The information processing device according to any one of Supplementary Notes 1 to 11,

in which the image acquisition means includes an image composition unit that combines a plurality of the commodity image in which a person is captured at different positions with respect to the commodity image including the person, and generates the commodity image in which the person is not included.

(Supplementary Note 13)

An information processing method including:

acquiring a commodity image obtained by imaging a commodity of a store;

performing image operation on the commodity image based on an operation instruction for the commodity image received from an information terminal of a customer; and

specifying a need of the customer for the commodity of the store based on the commodity image that has been subjected to operation.

(Supplementary Note 14)

A program causing a computer to:

acquire a commodity image obtained by imaging a commodity of a store;

perform image operation on the commodity image based on an operation instruction for the commodity image received from an information terminal of a customer; and

specify a need of the customer for the commodity of the store based on the commodity image that has been subjected to operation.

(Supplementary Note 15)

An information processing system including:

an information processing device that acquires a commodity image obtained by imaging a commodity of a store, and specifies a need of a customer for the commodity of the store based on the commodity image that has been subjected to operation by operation information on the commodity image from an information terminal of the customer; and

an information terminal that transmits operation information on image operation that has been performed on the commodity image transmitted from the information processing device, as an operation instruction.

The present invention has been described above using the above-described example embodiments as exemplary examples. However, the present invention is not limited to the above-described example embodiments. That is, various aspects that can be understood by those skilled in the art can be applied to the example embodiments in the present invention within the scope of the present invention.

This application is based upon and claims the benefit of priority from Japanese Patent application No. 2019 054692 filed on Mar. 22, 2019, the disclosure of which is incorporated herein in its entirety by reference.

### REFERENCE SIGNS LIST

100 information processing device
101 image acquisition unit
102 image operation unit
103 specification unit
121 order placement unit
131 image composition unit
150 camera
200 information terminal
201 display control unit
202 image operation instruction unit
900 computer
901 CPU
902 ROM
903 RAM
904 program
905 storage device
906 recording medium

What is claimed is:

1. An information processing device comprising:
a memory storing instructions; and
one or more processors configured to execute the instructions to:
acquire a commodity image obtained by imaging a commodity of a store;
operate the commodity image based on an operation instruction for the commodity image received from an information terminal of a customer; and
specify a need of the customer for the commodity of the store based on the commodity image that has been subjected to operation.

2. The information processing device according to claim 1, wherein
the one or more processors are further configured to execute the instructions to:
specify the commodity included in the commodity image that has been subjected to the operation, as the need of the customer.

3. The information processing device according to claim 1, wherein the one or more processors are further configured to execute the instructions to:
specify the commodity in a predetermined region in the commodity image that has been subjected to the operation, as the need of the customer.

4. The information processing device according to claim 1, wherein
the one or more processors are further configured to execute the instructions to: acquire a reception status of the operation instruction, and
specify the need of the customer from the commodity image that has been subjected to the operation in accordance with the reception status.

5. The information processing device according to claim 1, wherein
the commodity image includes a display fixture for displaying the commodity.

6. The information processing device according to claim 5, wherein
the one or more processors are further configured to execute the instructions to:
specify the need of the customer based on commodity coordinate data related to commodity arrangement of the display fixture and generated based on shelf allocation information of the display fixture and based on the commodity image that has been subjected to the operation.

7. The information processing device according to claim 1, wherein
the operation instruction is at least one of image enlargement operation, image rotation operation, and image movement operation for the commodity image.

8. The information processing device according to claim 1, wherein
the one or more processors are further configured to execute the instructions to: transmit at least one of the commodity image that has been acquired and the commodity image that has been subjected to the operation to the information terminal.

9. The information processing device according to claim 1, wherein
the one or more processors are further configured to execute the instructions to:
place an order of the commodity based on order placement information,
update the order placement information based on the need of the customer that has been specified.

10. The information processing device according to claim 9, wherein
the one or more processors are further configured to execute the instructions to
update the order placement information based on ranking of a number of needs that has been specified, based on the need of the customer that has been specified.

11. The information processing device according to claim 1,
wherein a target of the need of the customer is the commodity or a category of the commodity.

12. The information processing device according to claim 1, wherein
the one or more processors are further configured to execute the instructions to: include an image composition unit that combines a plurality of the commodity image in which a person is captured at different positions with respect to the commodity image including the person, and generates the commodity image in which the person is not included.

13. An information processing method comprising:
acquiring a commodity image obtained by imaging a commodity of a store;
performing image operation on the commodity image based on an operation instruction for the commodity image received from an information terminal of a customer; and
specifying a need of the customer for the commodity of the store based on the commodity image that has been subjected to operation.

14. A non-transitory computer readable storage medium including a program stored therein, the program causing a computer to:
acquire a commodity image obtained by imaging a commodity of a store;
perform image operation on the commodity image based on an operation instruction for the commodity image received from an information terminal of a customer; and
specify a need of the customer for the commodity of the store based on the commodity image that has been subjected to operation.

15. (canceled)
